(19) United States
(12) Patent Application Publication
(10) Pub. No.: US 2026/0131780 A1
(43) Pub. Date: May 14, 2026

(54) METHOD FOR ADAPTING RESPONSES OF AN ADVANCED DRIVER ASSISTANCE SYSTEM

(71) Applicant: GM Global Technology Operations LLC, Detroit, MI (US)

(72) Inventors: Michael John Aprile, Shelby Township, MI (US); Michael G. Carpenter, Romeo, MI (US); Chad T. Zagorski, Clarkston, MI (US); Shawn F. Granda, Troy, MI (US); Donald K. Grimm, Utica, MI (US)

(21) Appl. No.: 18/946,502

(22) Filed: Nov. 13, 2024

(51) Int. Cl. B60W 30/08; G07C 5/00; G08G 1/01; G08G 1/16

(52) U.S. Cl. CPC B60W 30/08; G07C 5/008; G08G 1/0129; G08G 1/16; B60W 2520/10; B60W 2520/105; B60W 2530/20; B60W 2540/18; B60W 2540/30; B60W 2552/15; B60W 2552/30; B60W 2555/20; B60W 2556/10; B60W 2556/45

(57) ABSTRACT

A method for adapting a response of an advanced driver assistance system (ADAS) equipped vehicle includes collecting telemetry data. The telemetry data includes crash events and near-crash events relative to a map. The method further includes collecting environmental data and performing an analysis of the telemetry data relative to the environmental data to determine crash risk factors. The crash risk factors correlate to an increased crash risk. The method further includes determining areas of increased crash risk based on the crash risk factors. The method further includes determining the location of the ADAS equipped vehicle relative to the map and collecting vehicle data from one or more sensors. The method further includes calculating an increased risk of vehicle crash index (IRVCI) based on the ADAS equipped vehicle's location and the vehicle data collected. The method further includes adapting the response of the ADAS equipped vehicle based on the IRVCI.

### INTRODUCTION

The present disclosure generally relates to an advanced driver assistance system (ADAS). More particularly, the present disclosure relates to a system and method that adapts responses of an ADAS equipped vehicle.

Vehicles are equipped with the ADAS to increase vehicle and road safety. The ADAS equipped vehicle includes sensors that collect data regarding the surrounding environment of the vehicle. The data is processed to create an alert or an automatic vehicle response. While the ADAS creates alerts and automatic vehicle responses, the ADAS does not adapt the timing of the alerts or the responses to environmental factors or to a driver's driving habits and preferences.

Thus, while current ADAS equipped vehicles achieve their intended purpose, there is a need for a new and improved system and method for adapting the responses of the ADAS equipped vehicle based on environmental, system, and personalization factors.

### SUMMARY

According to several aspects, a method for adapting a response of an advanced driver assistance system (ADAS) equipped vehicle is provided. The method includes collecting telemetry data from a plurality of remote vehicles. The telemetry data includes crash events and near-crash events relative to locations on a map. The method further includes collecting environmental data of the locations on the map. The environmental data is indicative of inherent characteristics of the locations. The environmental data includes road curvature, road grade, road surface, visibility, and weather conditions. The method further includes performing an analysis of the telemetry data relative to the environmental data of the locations to determine crash risk factors that correlate to an increased crash risk. The method further includes determining areas of increased crash risk based on the crash risk factors. The method further includes determining a location of the ADAS equipped vehicle relative to the map. The method further includes collecting vehicle data from one or more sensors mounted on the ADAS equipped vehicle. The vehicle data includes vehicle load, trailering status, tire pressure, tire wear, tire temperature, and spare tire mounted. The method further includes calculating an increased risk of vehicle crash index (IRVCI) based on the ADAS equipped vehicle's location relative to the areas of increased crash risk and the vehicle data. The method further includes adapting the response of the ADAS equipped vehicle based on the IRVCI.

In an additional aspect of the present disclosure, the method further includes collecting telemetry data from a cloud.

In another aspect of the present disclosure, the method further includes classifying the telemetry data as crash events when remote vehicles collide.

In another aspect of the present disclosure, the method further includes classifying the telemetry data as near-crash events when the remote vehicles activate alerts that are indicative of a near crash.

In another aspect of the present disclosure, the method further includes classifying the telemetry data as near crash events when the remote vehicles activate automatic vehicle responses that are indicative of a near crash.

In another aspect of the present disclosure, the crash risk factors include roadway curvature, traffic patterns, and intersection configurations.

In another aspect of the present disclosure, the method further includes locating the crash risk factors relative to the map.

In another aspect of the present disclosure, the method further includes adapting the ADAS equipped vehicle's response timing.

In another aspect of the present disclosure, the method further includes adapting the ADAS equipped vehicle's response aggressiveness.

According to several aspects, a method for adapting a response of an advanced driver assistance system (ADAS) equipped vehicle is provided. The method includes creating a driver profile. The driver profile is based on collected driving habits and collected driving preferences. The driving habits of the driver include vehicle speed, vehicle acceleration, vehicle deceleration, and steering inputs over a period of time. The method further includes calculating a driver's historical aggressiveness metric (D-HAM) by comparing the driving habits to a statistical mean. The method further includes collecting vehicle data from one or more sensors mounted on the ADAS equipped vehicle. The vehicle data includes vehicle load, trailering status, tire pressure, tire wear, tire temperature, and spare tire mounted. The method further includes collecting environmental data of locations on a map. The environmental data is indicative of inherent characteristics of the locations. The inherent characteristics include road curvature, road grade, road surface, visibility, and weather conditions. The method further includes collecting real-time vehicle inputs from the driver. The vehicle inputs include speed, acceleration, deceleration, steering inputs relative to the map. The method further includes performing an analysis of the vehicle data and the environmental data to determine crash risk factors when the vehicle inputs deviate from the D-HAM. The method further includes calculating a driver's predicted aggressiveness metric (D-PAM) from the crash risk factors based on the deviation of the D-HAM. The method further includes adapting the response of the ADAS equipped vehicle based on the D-PAM.

In another aspect of the present disclosure, the driving preferences include settings the driver has input into the ADAS.

In another aspect of the present disclosure, the method further includes collecting biometric data from a plurality of cabin sensors located within the ADAS equipped vehicle.

In another aspect of the present disclosure, calculating the D-HAM includes comparing the driver's speed to the statistical mean.

In another aspect of the present disclosure, calculating the D-HAM includes comparing the driver's acceleration to the statistical mean.

In another aspect of the present disclosure, calculating the D-HAM includes comparing the driver's deceleration to the statistical mean.

In another aspect of the present disclosure, calculating the D-HAM includes comparing the driver's steering inputs to the statistical mean.

In another aspect of the present disclosure, detecting deviation of the D-HAM occurs when the vehicle inputs fall outside a particular range from the D-HAM.

In another aspect of the present disclosure, the method further includes adapting the ADAS equipped vehicle's response timing.

In another aspect of the present disclosure, the method further includes adapting the ADAS equipped vehicle's response aggressiveness.

According to several aspects, a method for adapting a response of an advanced driver assistance system (ADAS) equipped vehicle is provided. The method includes collecting telemetry data from a plurality of remote vehicles. The telemetry data includes crash events and near-crash events relative to locations on a map. The method further includes collecting environmental data of the locations on the map. The environmental data is indicative of inherent characteristics of the locations. The environmental data includes road curvature, road grade, road surface, visibility, and weather conditions. The method further includes performing an analysis of the telemetry data relative to the environmental data of the locations to determine crash risk factors that correlate to an increased crash risk. The method further includes determining areas of increased crash risk based on the risk factors. The method further includes determining a location of the ADAS equipped vehicle relative to the map. The method further includes collecting vehicle data from one or more sensors mounted on the ADAS equipped vehicle. The vehicle data includes vehicle load, trailering status, tire pressure, tire wear, tire temperature, and spare tire mounted. The method further includes calculating an increased risk of vehicle crash index (IRVCI) based on the ADAS equipped vehicle's location relative to the areas of increased crash risk and the vehicle data. The method further includes creating a driver profile. The driver profile is based on collected driving habits, biometric data, and collected driving preferences. The driving habits of the driver include vehicle speed, vehicle acceleration, vehicle deceleration, and steering inputs over a period of time. The method further includes calculating a driver's historical aggressiveness metric (D-HAM) by comparing the driving habits to a statistical mean. The method further includes collecting real-time vehicle inputs from the driver including speed, acceleration, deceleration, steering inputs relative to the map. The method further includes performing an analysis of the vehicle data and the environmental data to determine crash risk factors when the vehicle inputs deviate from the D-HAM. The method further includes calculating a driver's predicted aggressiveness metric (D-PAM) from the crash risk factors based on the deviation of the D-HAM. The method further includes adapting the response of the ADAS equipped vehicle based on the IRVCI and the D-PAM.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic drawing of a system for adapting responses of an advanced driver assistance system (ADAS) equipped vehicle.

FIG. 2 is a flowchart of a method for adapting the responses of the ADAS equipped vehicle.

FIG. 3 is a flowchart of another method for adapting the responses of the ADAS equipped vehicle.

### DETAILED DESCRIPTION

The following description is merely exemplary in nature and is not intended to limit the present disclosure, application, or uses.

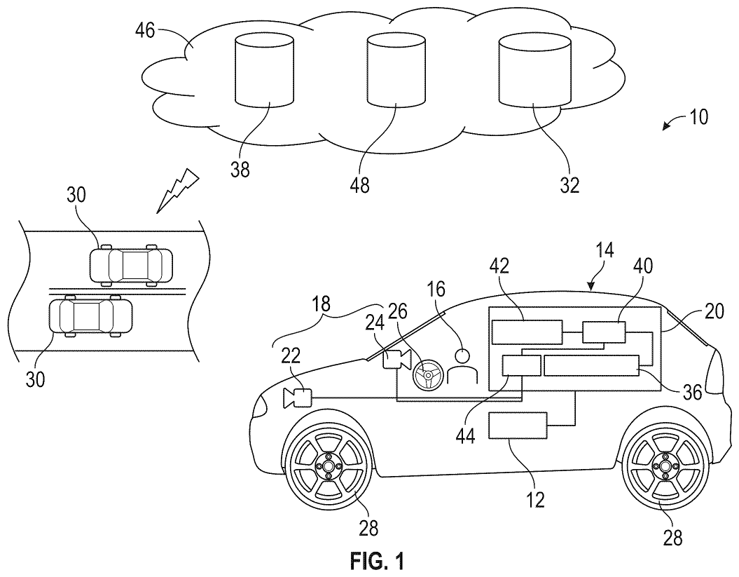

Referring to FIG. 1, a system 10 for adapting alerts and responses of an advanced driver assistance system (ADAS) 12 in an ADAS equipped vehicle 14 is shown. The ADAS 12 may provide various levels of driving automation, including Level 5, Level 4, Level 3, and Level 2 automation. For example, a Level 5 system indicates “full automation,” referring to the full-time performance by an automated driving system of aspects of the dynamic driving task under a number of roadway and environmental conditions that can be managed by a driver 16. A Level 4 system indicates “high automation,” referring to the driving mode-specific performance by an automated driving system of aspects of the dynamic driving task, even if the driver 16 does not respond appropriately to a request to intervene. In Level 3 vehicles, the vehicle systems perform the entire dynamic driving task (DDT) within the area that it is designed to do so. The driver 16 is only expected to be responsible for the DDT-fallback when the ADAS equipped vehicle 14 essentially “asks” the driver 16 to take over if something goes wrong or the ADAS equipped vehicle 14 is about to leave the zone where it is able to operate. In Level 2 vehicles, systems provide steering, brake/acceleration support, lane centering, and adaptive cruise control. However, even if these systems are activated, the driver 16 must be driving and constantly supervising the automated features.

The ADAS 12 includes various actuator devices (not shown) used to achieve the above-described levels of automation. The actuator devices control one or more vehicle features including, but not limited to, a propulsion system, a transmission system, a steering system, and a brake system (not shown). In various embodiments, the vehicle features may further include interior and/or exterior vehicle features such as, but are not limited to, doors, a trunk, and cabin features such as air, music, lighting, etc. Therefore, the alerts and the responses of the ADAS 12 include, but are not limited to, a collision avoidance system (CAS), lane departure warning (LDW), adaptive cruise control (ACC), blind spot monitoring (BSM), pedestrian detection (PD), driver monitoring system (DMS), traffic sign recognition (TSR), automatic parking system (APS), lane keep assist system (LKA), automatic emergency braking (AEB), etc.

The ADAS equipped vehicle 14 collects data through one or more sensors 18 that are disposed on and within the ADAS equipped vehicle 14. The one or more sensors 18 are in communication with a controller 20. The plurality of sensors 18 are configured to generate a signal that is indicative of the sensed observable conditions of the exterior environment and/or the interior environment of the ADAS equipped vehicle 14. The one or more sensors 18 may include, but are not limited to, one or more radars, one or more light detection and ranging (lidar) sensors, one or more proximity sensors, one or more odometers, one or more ground penetrating radar (GPR) sensors, one or more steering angle sensors, one or more global positioning systems (GPS) transceivers, one or more tire pressure sensors, one or more cameras (e.g., optical cameras and/or infrared cameras), one or more gyroscopes, one or more accelerometers, one or more inclinometers, one or more speed sensors, one or more ultrasonic sensors, one or more inertial measurement units (IMUs) and/or other sensors. For the purposes of clarity, only an environmental sensor 22 and a vehicle sensor 24 of the one or more sensors 18 is shown in FIG. 1.

The environmental sensor 22 is disposed on the ADAS equipped vehicle 14. The environmental sensor 22 senses observable conditions of the exterior of the ADAS equipped vehicle 14 such as environmental data. The environmental data includes road conditions and driving conditions surrounding the ADAS equipped vehicle 14. The road conditions include but are not limited to roadway curvature, traffic patterns, intersection configurations, paved, unpaved, presence of precipitation, etc. Additionally, the environmental data includes information about visibility of the road such as time of day and presence of fog, snow, rain, etc.

The vehicle sensor 24 is disposed on the ADAS equipped vehicle 14 and senses the driver's 16 biometric data and vehicle data. The biometric data collected enables the ADAS equipped vehicle 14 to identify changes in the emotional state of the driver 16. By sensing the biometric data, the ADAS equipped vehicle 14 can detect stressful events that lead to an increased crash risk. The biometric data includes but is not limited to eye tracking, eye squinting, face expression identification, body shifting sensor in seat, heart rate monitor in a steering wheel 26, voice volume, voice inflection, etc. The vehicle data includes factors that affect driving behavior such as vehicle load, trailering status, pressure of a tire 28, a wear of the tire 28, a temperature of the tire 28, if the tire 28 mounted is a spare, etc.

Remote vehicles 30 communicate third party data and telemetry data 32 to the controller 20 of the ADAS equipped vehicle 14 via a transceiver 36. The third-party data includes data that correlates with increased crash risk including weather data, crash data, a driver's 16 familiarity with a location, etc. The telemetry data 32 includes but is not limited to information about crash events and near-crash events relative to a map 38. Events are classified as the crash events when the remote vehicles 30 have collided. The events are classified as the near-crash events when the remote vehicles 30 activate alerts or activate an automatic vehicle response that are indicative of a near crash (i.e. steering inputs that exceed a steering threshold, braking inputs that exceed a braking threshold, etc.).

The controller 20, in the ADAS equipped vehicle 14, computes the ADAS equipped vehicle 14 response and alerts to promote safety. The controller 20 is a non-generalized electronic control device having a preprogrammed digital computer or processor 40, a memory 42, an input and output ports 44, and the transceiver 36.

The processor 40 can be a custom made or a commercially available processor, a central processing unit (CPU), a graphics processing unit (GPU), an auxiliary processor among several processors associated with the controller 20, a semiconductor-based microprocessor (in the form of a microchip or chip set), a macroprocessor, a combination thereof, or generally a device for executing instructions. The memory 42 is used to store data such as control logic, software applications, instructions, computer code, data, lookup tables, etc. The memory 42 includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code. The processor 40 is configured to execute the code or instructions.

The input and output ports 44 receive incoming data from the one or more sensors 18 and communicate the incoming data to the processor 40. The input and output ports 44 also receive outgoing data from the processor 40 and communicate an outgoing data to the environmental sensor 22 and the vehicle sensor 24. In addition, the input and output ports 44 are configured to wirelessly communicate to the one or more sensors 18 via the transceiver 36.

The transceiver 36 is configured to wirelessly communicate information to and from remote vehicles 30 and a cloud 46, such as but not limited to, other vehicles (“V2V” communication), infrastructure (“V2I” communication), remote systems at a remote call center (e.g., ON-STAR by GENERAL MOTORS) and/or personal devices. The ADAS equipped vehicle 14 may include one or more antennas and/or transceivers 36 for receiving and/or transmitting signals, such as cooperative sensing messages (CSMs). The transceiver 36 may be considered a sensor.

The cloud 46 stores the telemetry data 32, the map 38, and a driver profile 48. The remote vehicles 30 communicate the telemetry data 32 and the map 38 to the cloud 46 while the ADAS equipped vehicle 14 communicates the driver profile 48 to the cloud 46. The calculation of the driver profile 48 will be described in further detail below.

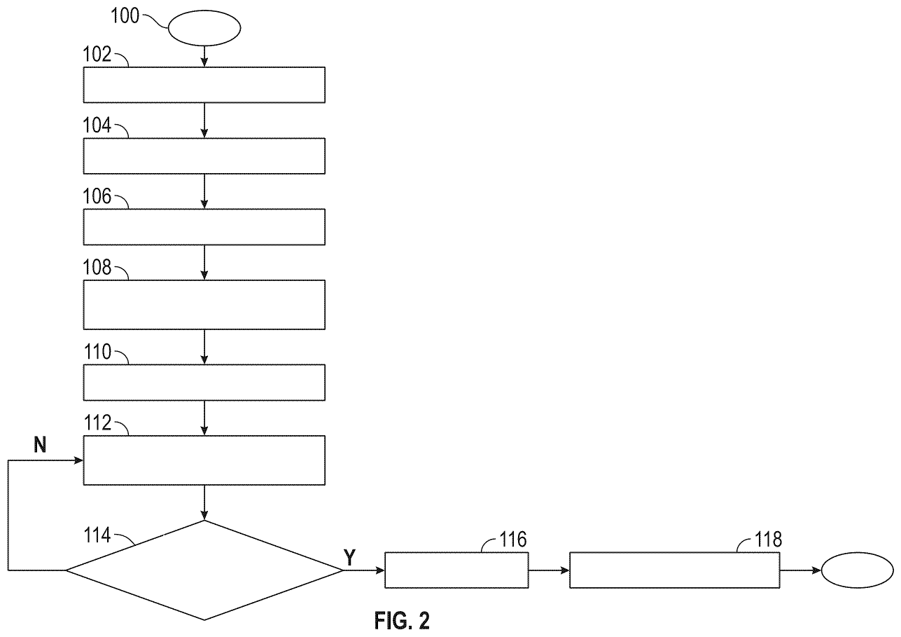

Referring to FIG. 2, a flowchart of a method 100 for adapting the ADAS equipped vehicle 14 responses based on a calculated increased risk of vehicle crash index (IRVCI) is shown. The method 100 begins with step 102, where the system 10 collects the telemetry data 32 communicated by the cloud 46 and by the remote vehicles 30 via the transceiver 36. The method 100 then proceeds to step 104. At step 104, the environmental data is collected. The method 100 proceeds to step 106.

At step 106, crash risk factors are identified. To determine the crash risk factors, the telemetry data 32 and the environmental data are received by the controller 20 and processed in the processor 40. The processor 40 analyzes the telemetry data 32 relative to the environmental data to determine factors that increase the crash risk. The crash risk factors are factors related to the environmental data that correlates to the crash events and the near-crash events. For example, crash risk factors may include roadway curvature, traffic patterns, intersection configurations, etc. The method 100 then proceeds to step 108.

At step 108, the areas of increased crash risks are determined. The areas of increased crash risk are determined by locating where the crash risk factors occur relative to the map 38. The method 100 proceeds to step 110.

At step 110, vehicle data is collected. The vehicle data includes factors relating to the ADAS equipped vehicle 14 that affect the driver's 16 driving behavior. Examples of vehicle data includes The vehicle data includes vehicle load, trailering status, pressure of the tire 28, the wear of the tire 28, the temperature of the tire 28, if the tire 28 mounted is a spare, etc. The method 100 then proceeds to step 112.

At step 112, the processor 40 determines the location of the ADAS equipped vehicle 14. The location of the ADAS equipped vehicle 14 is determined based on the ADAS equipped vehicle's 14 location relative to the map 38 using GPS. The method 100 proceeds to step 114.

At step 114, the proximity of the ADAS equipped vehicle 14 to the increased crash risk is determined by comparing the areas of increased crash risk and the location of the ADAS equipped vehicle 14. When the location of the ADAS equipped vehicle 14 is within an area of increased crash risk, the method 100 proceeds to step 116. When the ADAS equipped vehicle 14 is not within an area of increased crash risk, the method 100 returns to step 112. In another embodiment, if the ADAS equipped vehicle 14 is within a threshold range of the determined areas of increased crash risk, the ADAS equipped vehicle 14 is determined to be in proximity to the increased crash risk and the method proceeds to step 116. If the ADAS equipped vehicle 14 is not within the threshold range of the determined areas of increased crash risk, the method 100 returns to step 112.

At step 116, the IRVCI is calculated. The IRVCI is calculated based on the proximity of the ADAS equipped vehicle 14 to the increased crash risk identified and the vehicle data collected. The method 100 then proceeds to step 118.

At step 118, the ADAS 12 adapts the ADAS equipped vehicle 14 response based on the calculated IRVCI. For example, when the IRVCI is calculated and it is determined that the ADAS equipped vehicle 14 is in the proximity of a high risk environment, the ADAS creates earlier alerts and responses. However, when the IRVCI is calculated and it is determined that the ADAS equipped vehicle is not in the proximity of a high risk environment, the ADAS creates later alerts and responses. For example, when the ADAS equipped vehicle 14 is determined to be in proximity of the high risk environment (i.e., high precipitation rate, low evasive potential, high congestion, etc.) the ADAS equipped vehicle 14 undergoes ADAS 12 responses such as collision avoidance system (CAS) and/or automatic emergency breaking (AEB).

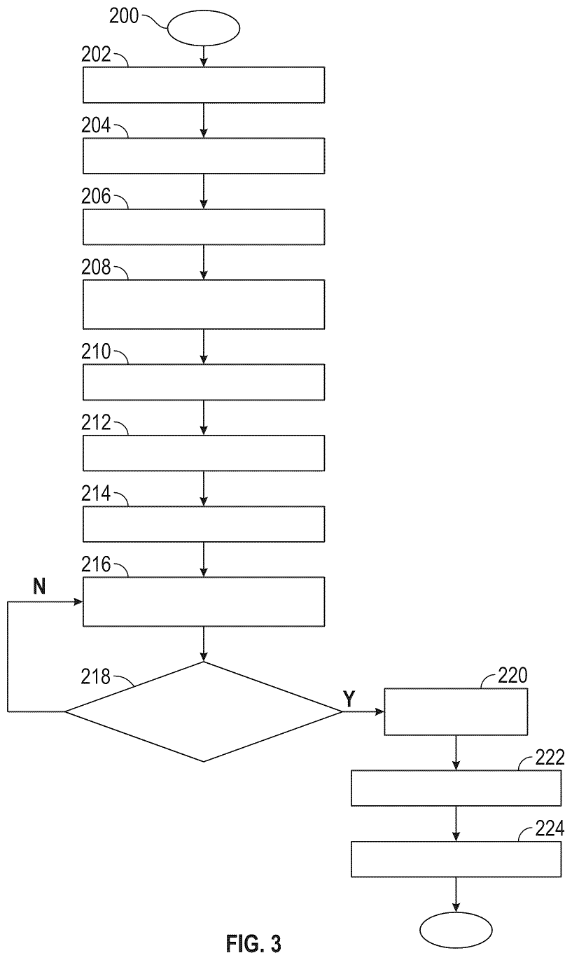

Referring to FIG. 3, a flowchart of a method 200 for adapting the ADAS 12 responses based on a calculated driver's predicted aggressiveness metric (D-PAM) is illustrated. The method 200 begins with step 202, where the ADAS equipped vehicle 14 identifies the driver's 16 driving habits. The ADAS 12 recognizes the vehicle inputs that are common for the driver 16 over a period of time. The ADAS 12 classifies the vehicle inputs that are common for the driver 16 over a period of time as the driver's 16 driving habits. The driving habits include vehicle speed, vehicle acceleration, vehicle deceleration, and steering inputs over a period of time. The method 200 proceeds to step 204.

At step 204, the driver's 16 driving preferences are identified. The driving preferences are settings the driver 16 has input into the ADAS 12. A non-limiting example, the driving preferences includes preferred timing for alerts and responses of the ADAS 12, driving aggressiveness, preferred route information, etc. The method 200 proceeds to step 206.

At step 206, the driver's 16 biometric data is collected. The driver's 16 biometric data is collected by the ADAS 12 over a period of time using the vehicle sensor 24. The ADAS 12 detects when the vehicle inputs vary under different biometric data. Examples of biometric data include eye tracking, eye squinting, face expression identification, body shifting sensor in seat, heart rate monitor in the steering wheel 26, voice volume, voice inflection, etc. The method 200 then proceeds to step 208.

At step 208, the driver profile 48 is created for the driver 16 of the ADAS equipped vehicle 14. The driver profile 48 includes the driver's 16 driving habits, the driver's 16 driving preferences, and the driver's 16 biometric data. The method 200 proceeds to step 210.

At step 210, the driver profile 48 is used to calculate a driver's historical aggressiveness metric (D-HAM). The D-HAM is calculated by comparing the driver profile 48 to a statistical mean. The statistical mean is preprogrammed in the ADAS 12 and stored in the controller 20. The statistical mean identifies average driving patterns for the driver 16 based on the driver profile 48. The method 200 proceeds to step 212.

At step 212, the vehicle data is collected. The vehicle data includes vehicle load, trailering status, tire pressure, and tire wear. The method 200 proceeds to step 214. At step 214, the environmental data is collected. The environmental data includes road conditions, precipitation, and visibility of the road. The road conditions include road curvature, road grade, and road surface. The method 200 proceeds to step 216.

At step 216, the ADAS 12 monitors the vehicle inputs in real time. The vehicle inputs include vehicle speed, vehicle acceleration, vehicle deceleration, and steering inputs collected in real time. The method 200 then proceeds to step 218.

At step 218, the calculated D-HAM is compared to the vehicle inputs. The vehicle inputs may deviate from the D-HAM. If the vehicle inputs fall outside the calculated D-HAM with a particular range, a deviation is detected. When the vehicle inputs deviate from the D-HAM, the method 200 proceeds to step 220. If no deviation from the D-HAM is detected, the method returns to step 216 where the vehicle inputs are continued to be monitored.

At step 220, crash risk factors are identified. The crash risk factors are identified based on the vehicle data and the environmental data. The crash risk factors are identified to determine the cause of the vehicle input deviation from the D-HAM. Examples of crash risk factors include roadway curvature, traffic patterns, intersection configurations, etc. The method 200 continues with step 222.

At step 222, a driver's predicted aggressiveness metric (D-PAM) is calculated. The D-PAM is calculated based on the identified crash risk factors. The D-PAM predicts the aggressiveness of the driver 16 and the vehicle inputs under the crash risk factors identified. The method 200 then proceeds to step 224.

At step 224, the ADAS equipped vehicle 14 response is adapted based on the calculated D-PAM. The D-PAM predicts the aggressiveness of the driver 16 under different crash risk factors. With this prediction, the ADAS 12 tailors the responses to enable the ADAS equipped vehicle 14 to maintain safety and decrease the amount of unwanted ADAS 12 responses. For example, less aggressive drivers 16 receive earlier alerts and earlier and more gentle vehicle responses. On the other hand, more aggressive drivers 16 receive later alerts and later and less gentle vehicle responses.

The system 10 and methods 100 and 200 to adapt the ADAS 12 response of the present disclosure offers several advantages. These include creating a tailored ADAS equipped vehicle 14 response based on environmental factors and the driver profile 48. Therefore, the ADAS 12 maintains safety while tailoring the responses to the environment and the driver 16.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for adapting a response of an advanced driver assistance system (ADAS) equipped vehicle, the method comprising:
collecting telemetry data from a plurality of remote vehicles, the telemetry data including crash events and near-crash events relative to locations on a map;
collecting environmental data of the locations on the map, the environmental data indicative of inherent characteristics of the locations including road curvature, road grade, road surface, visibility, and weather conditions;
performing an analysis of the telemetry data relative to the environmental data of the locations to determine crash risk factors that correlate to an increased crash risk;
determining areas of increased crash risk based on the crash risk factors;
determining a location of the ADAS equipped vehicle relative to the map;
collecting vehicle data from one or more sensors mounted on the ADAS equipped vehicle, the vehicle data including vehicle load, trailering status, tire pressure, tire wear, tire temperature, and spare tire mounted;
calculating an increased risk of vehicle crash index (IRVCI) based on the ADAS equipped vehicle's location relative to the areas of increased crash risk and the vehicle data; and
adapting the response of the ADAS equipped vehicle based on the IRVCI.

2. The method of claim 1, further comprising collecting the telemetry data from a cloud.

3. The method of claim 1, further comprising classifying the telemetry data as the crash events when remote vehicles collide.

4. The method of claim 1, further comprising classifying the telemetry data as the near-crash events when the remote vehicles activate alerts that are indicative of a near crash.

5. The method of claim 1, further comprising classifying the telemetry data as the near crash events when the remote vehicles activate automatic vehicle responses that are indicative of a near crash.

6. The method of claim 1, wherein the crash risk factors include roadway curvature, traffic patterns, and intersection configurations.

7. The method of claim 1, further comprising locating the crash risk factors relative to the map.

8. The method of claim 1, further comprising adapting the ADAS equipped vehicle's response timing.

9. The method of claim 1, further comprising adapting the ADAS equipped vehicle's response aggressiveness.

10. A method for adapting a response of an advanced driver assistance system (ADAS) equipped vehicle, the method comprising:
creating a driver profile, wherein the driver profile is based on collected driving habits and collected driving preferences, wherein the driving habits of the driver include vehicle speed, vehicle acceleration, vehicle deceleration, and steering inputs over a period of time;
calculating a driver's historical aggressiveness metric (D-HAM) by comparing the driving habits to a statistical mean;
collecting vehicle data from one or more sensors mounted on the ADAS equipped vehicle, the vehicle data including vehicle load, trailering status, tire pressure, tire wear, tire temperature, and spare tire mounted;
collecting environmental data of locations on a map, the environmental data indicative of inherent characteristics of the locations including road curvature, road grade, road surface, visibility, and weather conditions;
collecting real-time vehicle inputs from the driver including speed, acceleration, deceleration, steering inputs relative to the map;
performing an analysis of the vehicle data and the environmental data to determine crash risk factors when the vehicle inputs deviate from the D-HAM;
calculating a driver's predicted aggressiveness metric (D-PAM) from the crash risk factors based on deviation of the D-HAM; and
adapting the response of the ADAS equipped vehicle based on the D-PAM.

11. The method of claim 10, wherein the driving preferences include settings the driver has input into the ADAS.

12. The method of claim 10, further comprising collecting biometric data from a plurality of cabin sensors located within the ADAS equipped vehicle.

13. The method of claim 10, wherein calculating the D-HAM includes comparing the driver's speed to the statistical mean.

14. The method of claim 10, wherein calculating the D-HAM includes comparing the driver's acceleration to the statistical mean.

15. The method of claim 10, wherein calculating the D-HAM includes comparing the driver's deceleration to the statistical mean.

16. The method of claim 10, wherein calculating the D-HAM includes comparing the driver's steering inputs to the statistical mean.

17. The method of claim 10, wherein detecting deviation of the D-HAM occurs when the vehicle inputs fall outside a particular range from the D-HAM.

18. The method of claim 10, further comprising adapting the ADAS equipped vehicle's response timing.

19. The method of claim 10, further comprising adapting the ADAS equipped vehicle's response aggressiveness.

20. A method for adapting a response of an advanced driver assistance system (ADAS) equipped vehicle, the method comprising:
collecting telemetry data from a plurality of remote vehicles, the telemetry data including crash events and near-crash events relative to locations on a map;
collecting environmental data of the locations on the map, the environmental data indicative of inherent characteristics of the locations including road curvature, road grade, road surface, visibility, and weather conditions;
performing an analysis of the telemetry data relative to the environmental data of the locations to determine crash risk factors that correlate to an increased crash risk;
determining areas of increased crash risk based on the crash risk factors;
determining a location of the ADAS equipped vehicle relative to the map;
collecting vehicle data from one or more sensors mounted on the ADAS equipped vehicle, the vehicle data including vehicle load, trailering status, tire pressure, tire wear, tire temperature, and spare tire mounted;
calculating an increased risk of vehicle crash index (IRVCI) based on the ADAS equipped vehicle's location relative to the areas of increased crash risk and the vehicle data;
creating a driver profile, wherein the driver profile is based on collected driving habits, biometric data, and collected driving preferences, wherein the driving habits of the driver include vehicle speed, vehicle acceleration, vehicle deceleration, and steering inputs over a period of time;
calculating a driver's historical aggressiveness metric (D-HAM) by comparing the driving habits to a statistical mean;
collecting real-time vehicle inputs from the driver including speed, acceleration, deceleration, steering inputs relative to the map;
performing an analysis of the vehicle data and the environmental data to determine crash risk factors when the vehicle inputs deviate from the D-HAM;
calculating a driver's predicted aggressiveness metric (D-PAM) from the crash risk factors based on the deviation of the D-HAM; and
adapting the response of the ADAS equipped vehicle based on the IRVCI and the D-PAM.
